(19) United States
(12) Patent Application Publication
(10) Pub. No.: US 2008/0267730 A1
(43) Pub. Date: Oct. 30, 2008

(54) Screw Connection

(75) Inventors: Matthias Herntier, Wurmberg (DE); Leszek Wrobel, Rutesheim (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/104,773

(22) Filed: Apr. 17, 2008

(30) Foreign Application Priority Data
Apr. 26, 2007 (DE) 10 2007 019 699.9

(51) Int. Cl. F16B 33/00

(52) U.S. Cl. 411/357

(57) ABSTRACT

A screw connection fastens a first construction part to a second construction part. The first construction part has a first passage opening and the second construction part has a second passage opening set up in aligned fashion. A sleeve is attached to the second construction part, which has a sleeve opening disposed in an aligned fashion to the second passage opening, and which is supported axially with one end on the opening edge of the second construction. In addition, a screw going through both passage openings goes through the sleeve opening, and attaches the first construction part to the second construction part. A simplified construction results for the screw connection when the sleeve is attached screw tight to the second construction part, and the sleeve opening has a thread into which the screw is screwed to attach the first construction part to the second construction part.

### CROSS-REFERENCE TO RELATED APPLICATION

This application claims the priority, under 35 U.S.C. § 119, of German application DE 10 2007 019 699.9, filed Apr. 26, 2007; the prior application is herewith incorporated by reference in its entirety.

### BACKGROUND OF THE INVENTION

### Field of the Invention

This invention concerns a screw connection to fasten a first construction part to a second construction part in the shape of a sheet metal part. The first construction part has a first passage opening and the second construction part has a second passage opening. The two passage openings are disposed aligned to each other and a sleeve is attached to the second construction part. The sleeve has a sleeve opening oriented in an aligned manner to the second passage opening and is supported axially with an end on an opening edge of the second construction part that surrounds the second passage opening. A screw reaches into the sleeve opening and goes through both passage openings, and with which the first construction part is attached to the second construction part.

A screw connection is known from U.S. Pat. No. 2,327,585 with which a first construction part is fastenable to a second construction part. The first construction part involves a sheet metal wall, while the second construction part is a bearing sheet metal part. The first construction part has a passage opening, while the second construction part has second passage opening that is disposed aligned to it. A sleeve is attached to the second construction part, which has a sleeve opening oriented in line with the second passage opening and that with one end axially supports the opening edge of the second construction part that surrounds the passage opening. In addition, a screw is planned that goes through the two passage openings and that reaches into the sleeve and with which the first construction part is fastened to the second construction part.

In the known screw connection, the second construction part has a bowl shaped receptacle on the side turned away from the first construction part; the receptacle has the edge of the opening on the end turned toward the first construction part. The sleeve is inserted axially into the receptacle, in which way it is fastened to the second construction part. The sleeve opening completely goes through the sleeve, and the screw completely goes through the sleeve and completely through the second construction part as well. To this end the second construction part has an arranged third passage opening that is aligned with the other two passage openings. On one end the screw has a screw head and is screwed in on the other end with a nut, in which way the two construction parts are fastened to each other. The sleeve serves here as a stiffening body to be able to receive the pressure forces introduced by the screwing together into the second construction part.

### BRIEF SUMMARY OF THE INVENTION

It is accordingly an object of the invention to provide a screw connection that overcomes the above-mentioned disadvantages of the prior art devices of this general type, which gives an improved embodiment to the screwed-in connection of the passage of the type noted, one that is characterized by an economical way of being achieved.

With the foregoing and other objects in view there is provided, in accordance with the invention, a screw connection for fastening a first construction part to a second construction part shaped as a sheet metal part. The first construction part has a first passage opening, the second construction part has a second passage opening, and the first and second passage openings are disposed aligned with each other. The screw connection contains a sleeve attached to the second construction part. The sleeve has a sleeve opening that is oriented in an aligned manner to the second passage opening. The sleeve opening has a thread. The sleeve has an end and is supported axially with the end on an opening edge of the second construction part that surrounds the second passage opening. A screw reaches into the sleeve opening and goes through both the first and second passage openings, and with the screw the first construction part is attached to the second construction part. The sleeve is fastened screw tight to the second construction part via the screw engaging the thread of the sleeve opening, into the thread the screw being screwed to fasten the first construction part to the second construction part.

The invention is based on the general idea of attaching the sleeve to the second construction component screw tight and to provide its sleeve opening with a thread into which the screw is screwed. In this manner of construction, the second construction component is detached from the pull forces that are generated by the screwing in. In addition, the suggested screw connection requires fewer parts, by which means it is realizable more economically.

In advantageous embodiments, the sleeve can be attached to the second construction part in an area away from the edge of the opening, in which way it is possible in particular to support the forces generated by the torque that may be transferred by the screw connection. In addition, an intensive stiffening of the second construction component may be achieved by an appropriate choice and positioning of the attachment places with which the sleeve is attached to the second construction part.

It is obvious that the characteristics noted above and still to be discussed are usable not only in the combination given in each case, but also in other combinations or standing alone, all without leaving the framework of the present invention.

In accordance with an added feature of the invention, the sleeve is shaped as a standing sleeve having a standing collar supported axially flat on the opening edge. The standing collar is supported on the opening edge of the second construction part turned to an inner side of the second construction part. Alternatively, the standing collar is supported on the opening edge of the second construction part turned to an outer side of the second construction part.

In accordance with another feature of the invention, the sleeve opening is shaped like a passage opening going completely through the sleeve, the sleeve opening is shaped like a blind opening in the sleeve. The sleeve has axially one behind the other a thread part containing the sleeve opening and a bolt part shaped as a complete body.

In accordance with a further feature of the invention, the second construction part is shaped as a hollow body having an interior stiffened with a stiffening body, the sleeve is attached to the stiffening body. The sleeve goes through the stiffening body and is attached to the stiffening body on both sides. Alternatively, the second construction part is shaped as a hollow body and the hollow body is stiffened on an inside with a stiffening body, the sleeve goes through the stiffening body without touching the stiffening body.

In accordance with an additional feature of the invention, the second construction part is a hollow body, and the sleeve ends in an inside of the second construction part. Alternatively, the second construction part is a hollow body, and the sleeve goes through the second construction part.

In accordance with a concomitant feature of the invention, the sleeve goes through the second construction part and is attached to the second construction part on both sides.

Other features which are considered as characteristic for the invention are set forth in the appended claims.

Although the invention is illustrated and described herein as embodied in a screw connection, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal sectional view through a screw connection according to the invention; and

FIG. 2 is a diagrammatic, longitudinal view as in FIG. 1, but in another embodiment.

### DETAILED DESCRIPTION OF THE INVENTION

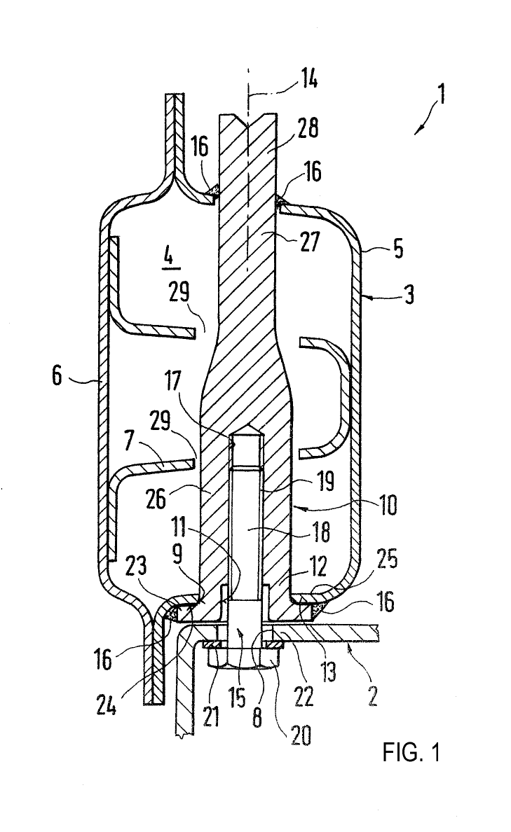

Referring now to the figures of the drawing in detail and first, particularly, to FIG. 1 thereof, there is shown a screw connection that serves to attach a partly shown first construction part 2 to a second construction part 3, also shown only partly here. Here it involves a second construction part 3 and a sheet metal part, which is formed of at least some sheet metal pieces manufactured by shaping. In contrast, the first construction part 2 can basically be any construction part. For example, the first construction part 2 may involve a cast part or an extrusion press profile. The first construction part 2 may also involve a sheet metal part.

The second construction part 3 is here shaped as a hollow body and thus has an inner space or an interior 4. The second construction part 3 is here composed of two shell-shaped sheet metal bodies 5 and 6, which enclose the interior 4. The two shell-shaped bodies 5 and 6 may for example be attached to each other through soldered points, not shown, or through soldered seams. In addition, in the embodiments shown here a stiffening body 7 is also planned, which is arranged in the interior 4 of the second construction part 3 and stiffens it. For example, the stiffening body 7 is also a sheet metal part. The stiffening body 7 supports the two shell-shaped sheet metal parts 5 and 6, in which way a stiffening effect already results. In addition, the stiffening body 7 may be fastened to at least one of the two shell bodies 5 and 6, such as through the soldered points or soldered seams not shown here.

Through the fastening of the stiffening body 7 to one of the shell bodies 5 or 6 or to both shell bodies 5 and 6, the stiffness of the second construction part 3 can also be increased. In particular, the second construction part 3 can be shaped as a carrier, such as for the body structure of a motor vehicle.

The first construction part 2 has a first passage opening 8, and the second construction part 3 has a second passage opening 9. In the assembled state shown, the two passage openings 8 and 9 are disposed aligned with each other.

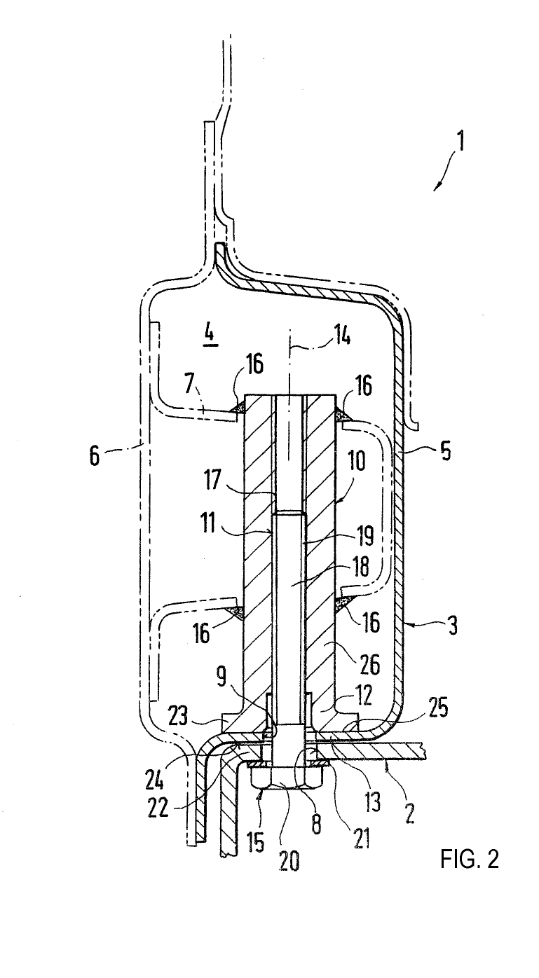

A sleeve 10 is attached to the second construction part 3. The sleeve 10 has a sleeve opening 11. The sleeve 10 is so arranged in the second construction part 3 that the sleeve opening 11 is aligned with the second passage opening 9, and thus is essentially oriented coaxially. Moreover, the sleeve 10 is axially supported with end 12 on an edge of the opening 13 turned toward the first construction part 2. This edge of the opening 13 encloses the second passage opening 9 and is thus a component of the second construction part 3. The concept “axial” refers here to a longitudinal central axis 14 of the sleeve 10. The sleeve 10 is characterized among other things by its axial extent being greater than its diameter. In particular its axial length is at least twice as big as its diameter. In the example according to FIG. 1, the sleeve 10 is about four times longer than its diameter. In the example according to FIG. 2, the sleeve is about three times longer than its diameter.

The screw connection also encloses a screw 15. This is inserted through both passage openings 8 and 9 and reaches into the sleeve opening 11.

The sleeve 10 is attached screw tight to the second construction piece 3. This is done preferably with soldered connections 16, which for example can be done as soldered seams or soldered points. In addition, the sleeve opening 11 has a thread 17, which is here set up as an inner thread. The screw 15 has on its shaft 18 a thread 19 complementary to the thread 17 of the sleeve opening 11. In the assembled state as shown, the screw 15 is screwed into the sleeve 10, whereby the first construction part 2 is attached to the second construction part 3. The screw 15 has a screw head 20, which is here supported axially by a disk 21 on an edge of the opening 22, which encloses the first passage opening 8. Accordingly, the last named opening edge 22 is a component of the first construction part 2.

With the help of the screw connection 1, the first construction part 2 can be attached to the second construction part 3 with great screw energy, without it thereby coming in the second construction part 3 into a draw load coaxially to the longitudinal axis 14 of the sleeve 10.

In the embodiments shown here, the sleeve 10 is shaped as a spacer sleeve. Such a spacer sleeve is characterized by a standing collar 23 that stands apart on the end. On the screw connection 1, it is formed on the end 12 of the sleeve 10 that is turned to the first construction part 2. The standing collar 23 here stands apart from the other sleeve body radially in relation to the longitudinal central axis 14, and forms the axial end wall of the sleeve 10 on the assigned end 12. In the assembled state, the sleeve 10 is supported axially over the standing collar 23 on the edge of the opening 13. In the embodiment shown in FIG. 1, the standing collar 23 is supported at the opening edge 13 on an outside 24 of the second construction part 3 turned to the first construction part 2. In contrast, the standing collar 23 shown in the embodiment in FIG. 2 is supported at the opening edge 13 on an inside 25 of the second construction part 3 turned to the first construction part 2.

In the embodiment shown in FIG. 1, the sleeve opening 11 is shaped as a blind opening that ends in the interior of the sleeve 10. In contrast, in the embodiment according to FIG. 2 the sleeve opening 11 is shaped as a passage opening that completely goes through the sleeve 10.

In the embodiment shown in FIG. 1, the sleeve 10 essentially has two axial sections, namely, one thread section 27 turned to the first construction part 2 and one bolt section distanced from the first construction part 2. While the thread section 26 contains the sleeve opening 11, the bolt section has a full profile and is thus shaped as a complete body. In this way the bolt section 27 may have a smaller diameter then the thread section 26 with the same holding power. Moreover, the sleeve 10 in the embodiment shown in FIG. 1 is so dimensioned that it pushes through both the stiffening body 7 and the second construction part 3. In this way it is possible to fasten the sleeve 10 to the second construction part 3. Correspondingly, the sleeve 10 here is welded to the end 12 in the area of the standing collar 23 turned to the first construction part 2 with the second construction part 3. Moreover, the collar 10 here is fastened in the area to an end 28 distanced from the first construction part 2 and to the second construction part 3. In this way an intensive stiffening of the second construction part 3 can be achieved with the help of the bolt 10. Among other things, the bolt 10 can accept torque through its fastening elements (soldered connections 16) separated axially from one another; the torque can be transferred from the first construction part 2 via the screw connection 1 to the second construction part 3.

In the embodiment shown in FIG. 1, the collar goes through the stiffening body 7 without touching, in particular with radial play 29. A fastening of the sleeve 10 to the stiffening body 7 is not foreseen here.

The sleeve protrudes in the embodiment shown in FIG. 1 from the side of the second construction part 3 on the side away from the first construction part 2. In particular, the sleeve 10 can have a polygonal outer edge on the end 28 away from the first construction part in order to make the handling of the sleeve 10 easier. The polygonal outer edge for example is formed on the bolt section 27.

In the embodiment shown in FIG. 2, the sleeve 10 is pushed through the stiffening body 7, and is so dimensioned that it ends in the interior 4 of the second construction part 3. The sleeve 10 is here not attached to the shell bodies 5, 6 but only to the stiffening body 7. The sleeve 10 is intentionally here attached on both sides to the stiffening body 7. For example, the soldered connections 16 are here shaped appropriately. In this embodiment, the sleeve 10 is arranged completely in the interior 4 of the second construction part 5. In particular, the sleeve 10 is thus capped in the second construction part 3. In this manner of construction, the soldered connections 16 can in particular be protected from damaging environmental influences.

In the embodiment shown in FIG. 2, the screwing, aided by the screw 15, leads to an axial bracing of the second construction part 3 in the area of the opening edge 13 axially between the first constructing part 2 and the standing collar 23 of the sleeve 10. In this an intensive fixing for the standing collar 23 to the second construction part 3 results, in which way the stiffening effect of the sleeve 10 within the screw connection 1 is also improved.

1. A screw connection for fastening a first construction part to a second construction part shaped as a sheet metal part, the first construction part has a first passage opening formed therein, the second construction part has a second passage opening formed therein and the first and second passage openings are disposed aligned to each other, the screw connection comprising:
a sleeve attached to the second construction part, said sleeve having a sleeve opening formed therein and oriented in an aligned manner to the second passage opening, said sleeve opening having a thread, said sleeve having an end and being supported axially with said end on an opening edge of the second construction part that surrounds the second passage opening; and
a screw reaching into said sleeve opening and going through both the first and second passage openings, and with said screw the first construction part is attached to the second construction part, said sleeve being fastened screw tight to the second construction part via said screw engaging said thread of said sleeve opening, into said thread said screw being screwed to fasten the first construction part to the second construction part.

2. The screw connection according to claim 1, wherein said sleeve is shaped as a standing sleeve having a standing collar supported axially flat on the opening edge.

3. The screw connection according to claim 2, wherein said standing collar is supported on the opening edge of the second construction part turned to an inner side of the second construction part.

4. The screw connection according to claim 2, wherein said standing collar is supported on the opening edge of the second construction part turned to an outer side of the second construction part.

5. The screw connection according to claim 1, wherein said sleeve opening is shaped like a passage opening going completely through said sleeve, said sleeve opening is shaped like a blind opening in said sleeve.

6. The screw connection according to claim 1, wherein said sleeve has axially one behind the other a thread part containing said sleeve opening and a bolt part shaped as a complete body.

7. The screw connection according to claim 1, wherein the second construction part is shaped as a hollow body having an interior stiffened with a stiffening body, said sleeve is attached to the stiffening body.

8. The screw connection according to claim 7, wherein said sleeve goes through the stiffening body and is attached to the stiffening body on both sides.

9. The screw connection according to claim 7, wherein the second construction part is shaped as a hollow body and the hollow body is stiffened on an inside with a stiffening body, said sleeve goes through the stiffening body without touching said stiffening body.

10. The screw connection according to claim 1, wherein the second construction part is a hollow body, and said sleeve ends in an inside of the second construction part.

11. The screw connection according to claim 1, wherein the second construction part is a hollow body, said sleeve goes through the second construction part.

12. The screw connection according to claim 1, wherein said sleeve goes through the second construction part and is attached to the second construction part on both sides.
